(19) United States
(12) Patent Application Publication
(10) Pub. No.: US 2026/0264172 A1
(43) Pub. Date: Sep. 10, 2026

(54) METHOD OF MANUFACTURING VEHICLE BODY FRAME STRUCTURE

(71) Applicant: HONDA MOTOR CO., LTD., Tokyo (JP)

(72) Inventors: Takayuki YAMADA, Wako-shi (JP); Satoru AKAO, Wako-shi (JP)

(21) Appl. No.: 19/545,882

(22) Filed: Feb. 20, 2026

(30) Foreign Application Priority Data
Mar. 7, 2025 (JP) 2025-036819

(51) Int. Cl. B23K 26/244; B23K 101/00

(52) U.S. Cl. CPC B23K 26/244; B23K 2101/006

(57) ABSTRACT

A method of manufacturing a vehicle body frame structure includes: a clamping step of superposing and clamping flanges of an inner panel and a stiffener using a number of clamp members placed at intervals; a laser welding step of executing continuous laser welding between the adjacent clamp members to form a number of laser welds of predetermined length; a clamping release step of disengaging the clamp members; and a spot welding step of superposing an outer panel made of galvanized steel sheet on an exterior side of the laser-welded inner panel and stiffener, and spot welding the flanges of the inner panel, stiffener, and outer panel, at spots between the adjacent laser welds, to form a number of spot welds.

### CROSS-REFERENCE TO RELATED APPLICATION

This application claims the benefit of priority under 35 U.S.C. §119 to Japanese Patent Application No. 2025-036819 filed on March 7, 2025, the entire contents of which are incorporated herein by reference.

### TECHNICAL FIELD

The present invention relates to a method of manufacturing a vehicle body frame structure.

### BACKGROUND OF THE INVENTION

Research and development has been conducted recently on weight reduction that contributes to energy efficiency, in order to ensure that more people can access affordable, dependable, sustainable, and advanced energy sources. Japanese Patent No. 7059803 (hereinbelow, referred to as Patent Document 1) discloses a technique in which a first vehicle body panel and a second vehicle body panel, adjacent to an interior side of the first vehicle body panel, are joined by spot welding, and then a surface panel is placed on an exterior side of the first vehicle body panel, followed by laser welding conducted between the surface panel and adjacent spot weld marks to join the surface panel to the exterior side of the first vehicle body panel.

### SUMMARY OF THE INVENTION

### Problems to be Solved

The technique of Patent Document 1 involves joining by spot welding two metal panels on the interior side, such as hot press materials contributing to rigidity, at predetermined intervals between adjacent weld spots. If these metal panels contributing to rigidity could be welded seamlessly, rigidity would be enhanced to allow further weight reduction. In this respect, the technique of Patent Document 1 has room for enhancement.

The present invention has been devised in view of the above-described point and is intended to provide a method of manufacturing a vehicle body frame structure in which three metal panels forming a vehicle body are joined with higher rigidity than prior art. This ultimately contributes to energy efficiency.

### Solution to Problem

To solve the above-identified problems, a method of manufacturing a vehicle body frame structure according to the present invention is used to manufacture a vehicle body frame structure with an inner panel, a stiffener, and an outer panel made of galvanized steel sheet superposed in this order from an interior side of a vehicle and flanges, respectively provided on the inner panel, stiffener, and outer panel, joined together, the method including: a clamping step of superposing and clamping the flanges of the inner panel and stiffener using a number of clamp members placed at intervals; a laser welding step of executing continuous laser welding between the adjacent clamp members to form a number of laser welds of predetermined length to join the flanges of the inner panel and stiffener; a clamping release step of disengaging the clamp members; and a spot welding step of superposing the outer panel on an exterior side of the laser-welded inner panel and stiffener, and spot welding the flanges of the inner panel, stiffener, and outer panel, at spots between the adjacent laser welds, to form a number of spot welds.

### Advantageous Effects of the Invention

The present invention provides a method of manufacturing a vehicle body frame structure to join three metal panels forming the vehicle body with higher rigidity than prior art. This ultimately contributes to energy efficiency.

### BRIEF DESCRIPTION OF DRAWINGS

FIG. 1 is an exploded perspective view of three panels of a vehicle body frame structure according to an embodiment;

FIG. 2 is a side view of an inner panel and a stiffener joined together;

FIG. 3 is a side view of the inner panel, stiffener, and an outer panel joined together;

FIG. 4A is a side view of the inner panel and stiffener fixed by clamp members;

FIG. 4B is a cross-sectional view taken along a line IVB—IVB in FIG. 4A;

FIG. 5 is a side view of the inner panel and stiffener laser-welded;

FIG. 6A is a schematic perspective view of wobble welding and wobble weld marks;

FIG. 6B is a schematic cross-sectional view of wobble welding;

FIG. 7 is a side view of the panels with the clamp members disengaged after laser welding;

FIG. 8 is a side view of the outer panel placed on an exterior side of the stiffener;

FIG. 9 is a side view of the inner panel, stiffener, and outer panel joined together by spot welding;

FIG. 10 is a cross-sectional view taken along a line X—X in FIG. 9;

FIG. 11 is a cross-sectional view taken along a line XI—XI in FIG. 9;

FIG. 12 is a partially enlarged view of a lower end and its vicinity of a center pillar during a laser welding step; and

FIG. 13 is a schematic side view of a movable clamp.

### DETAILS DESCRIPTION

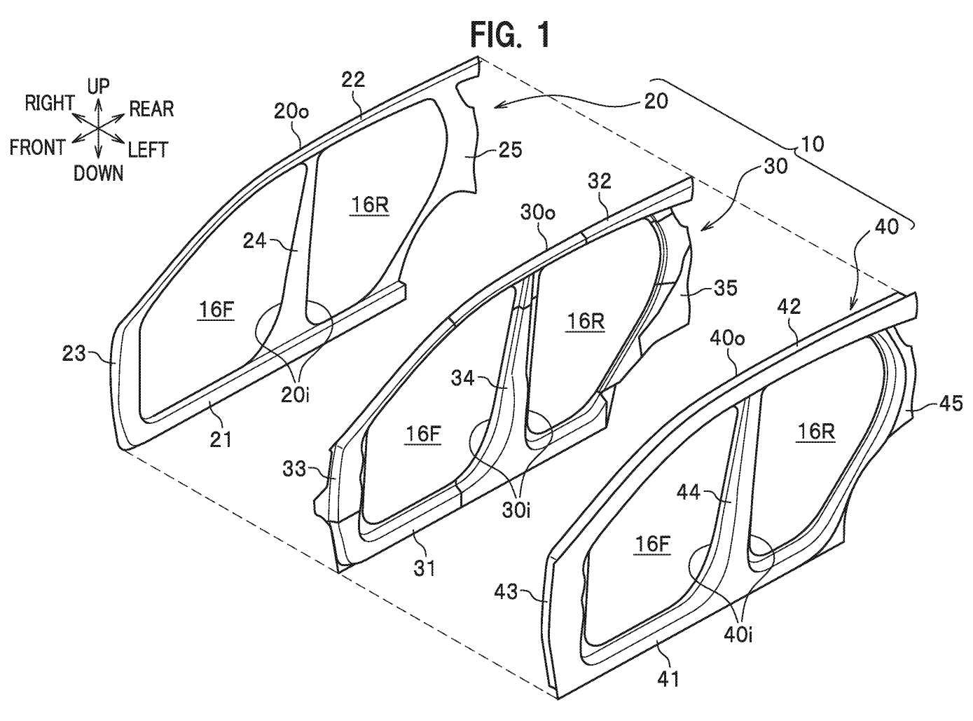

A vehicle body frame structure according to an embodiment is described in detail, with reference to the drawings as appropriate. The embodiment shows a case where the present invention is applied to panels at around one or more door openings of a vehicle body. In the following description, directions are based on the front, rear, right, left, up, and down as shown in FIG. 1.

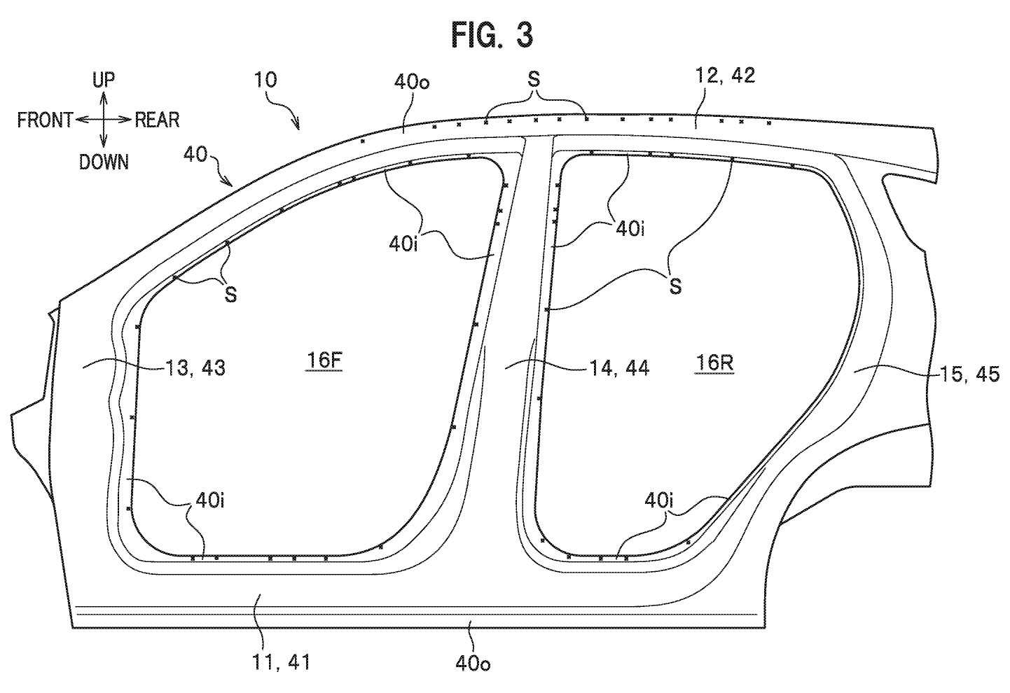

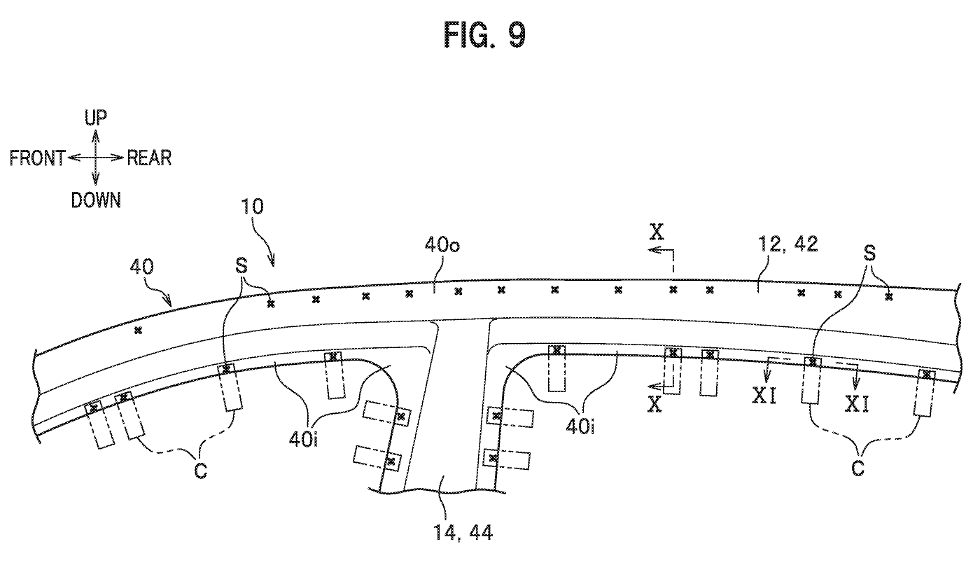

As shown in FIG. 1, a vehicle body frame structure 10 according to the embodiment is a framework at each side of a vehicle body. The vehicle body frame structure 10 is formed with a total of three panels – an inner panel 20, a stiffener 30, and an outer panel 40 – joined in this order from an interior side of a vehicle. As shown in FIG. 3, the vehicle body frame structure 10 includes: a side sill 11 extending longitudinally at a lower part of the vehicle body; a roof rail 12 extending longitudinally at an upper part of the vehicle body; a front pillar 13 connecting a front end of the side sill 11 with that of the roof rail 12; a center pillar 14 connecting a middle portion of the side sill 11 with that of the roof rail 12; and a rear pillar 15 connecting a rear end of the side sill 11 with that of the roof rail 12. The side sill 11, roof rail 12, front pillar 13, center pillar 14, and rear pillar 15 define a hollow structure when the three panels are joined (see FIG. 10). The vehicle body frame structure 10 also includes a front door opening 16F serving as an entrance to a front seat, and a rear door opening 16R serving as an entrance to a rear seat. Note that when there is no need of distinguishing between the front door opening 16F and rear door opening 16R, they may each be simply referred to as a door opening 16.

As shown in FIG. 1, the inner panel 20 is a structural member placed as the innermost one of the three panels. The inner panel 20 is made of high-tensile steel sheet (also referred to as “high-tensile material”) with high tensile strength. The inner panel 20 includes: a side sill portion 21 extending longitudinally at the lower part of the vehicle body; a roof rail portion 22 extending longitudinally at the upper part of the vehicle body; a front pillar portion 23 connecting a front end of the side sill portion 21 with that of the roof rail portion 22; a center pillar portion 24 connecting a middle portion of the side sill portion 21 with that of the roof rail portion 22; and a rear pillar portion 25 connecting a rear end of the side sill portion 21 with that of the roof rail portion 22. The side sill portion 21, roof rail portion 22, front pillar portion 23, center pillar portion 24, and rear pillar portion 25 have a shared inner flange 20i extending toward the door opening 16. The inner flange 20i is continuously provided so as to surround the periphery of the door opening 16. In other words, the inner flange 20i is formed along the door opening. Likewise, the side sill portion 21, roof rail portion 22, front pillar portion 23, and rear pillar portion 25 have a shared outer flange 20o extending toward the opposite side thereof to the door opening 16. The outer flange 20o is provided along an outer edge of the inner panel 20.

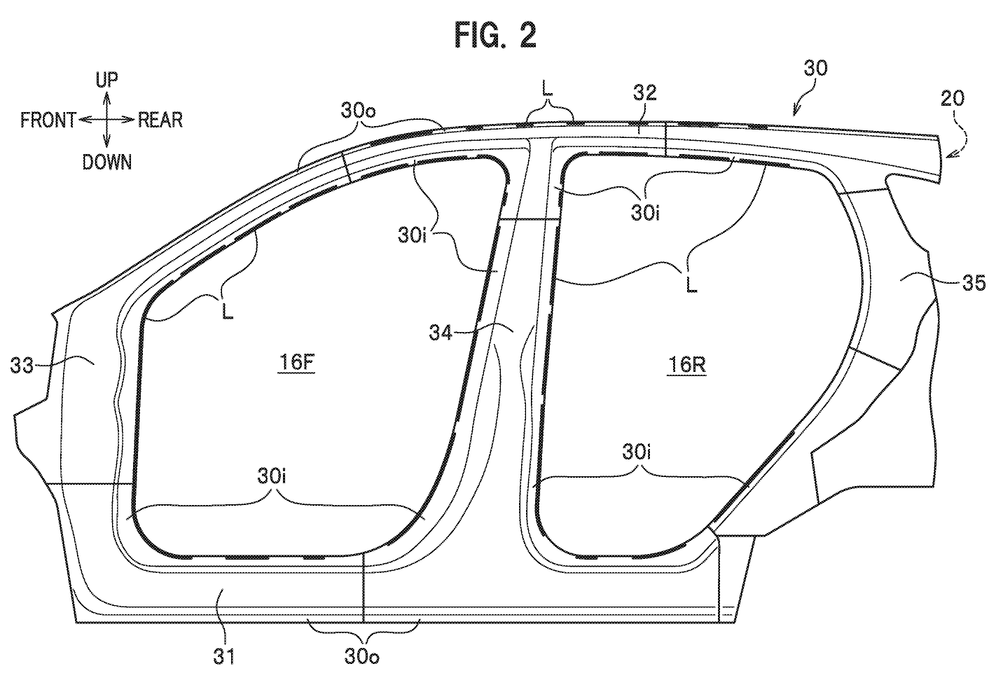

As shown in FIGS. 1 and 2, the stiffener 30 is a structural member located in the middle of the three panels. The stiffener 30 is also made of high-tensile steel sheet (also referred to as “high-tensile material”) with high tensile strength. The stiffener 30 includes: a side sill portion 31, a roof rail portion 32, a front pillar portion 33, a center pillar portion 34, and a rear pillar portion 35, as with the inner panel 20. The side sill portion 31, roof rail portion 32, front pillar portion 33, center pillar portion 34, and rear pillar portion 35 of the stiffener 30 have a shared inner flange 30i extending toward the door opening 16. The inner flange 30i is continuously provided so as to surround the periphery of the door opening 16. In other words, the inner flange 30i is formed along the door opening. Likewise, the side sill portion 31, roof rail portion 32, front pillar portion 33, and rear pillar portion 35 of the stiffener 30 have a shared outer flange 30o extending toward the opposite side thereof to the door opening 16. The outer flange 30o is provided along an outer edge of the stiffener 30.

As shown in FIGS. 1 and 3, the outer panel 40 is a structural member located outermost of the three panels. Note that the outer panel 40 also serves as a design component (exterior panel). The outer panel 40 is made of galvanized steel sheet, for example, which is thinner and has lower strength than high-tensile steel sheet. The outer panel 40 includes: a side sill portion 41, a roof rail portion 42, a front pillar portion 43, a center pillar portion 44, and a rear pillar portion 45, as with the inner panel 20 and stiffener 30. The side sill portion 41, roof rail portion 42, front pillar portion 43, center pillar portion 44, and rear pillar portion 45 of the outer panel 40 have a shared inner flange 40i extending toward the door opening 16. The inner flange 40i is continuously provided so as to surround the periphery of the door opening 16. In other words, the inner flange 40i is formed along the door opening. Likewise, the side sill portion 41, roof rail portion 42, front pillar portion 43, and rear pillar portion 45 of the outer panel 40 have a shared outer flange 40o extending toward the opposite side thereof opposite to the door opening 16. The outer flange 40o is provided along an outer edge of the outer panel 40.

The inner panel 20 and stiffener 30 are formed into panel-like (frame-like) shapes, with two or more elongated members, each made of high-tensile steel sheets pressed into a predetermined form, joined together longitudinally. Meanwhile, the outer panel 40 is formed into an integrated panel-like (frame-like) shape, with a single large, galvanized steel sheet pressed and punched out.

As shown in FIG. 2, the inner panel 20 and stiffener 30 have the inner flanges 20i and 30i, as well as outer flanges 20o and 30o, thereof joined together by laser welding. Note that a reference sign L in FIG. 2 denotes a laser weld L formed in a bead shape of predetermined length by laser welding. The laser welds L of the embodiment at the inner flanges 20i and 30i are provided along the entire periphery of the front door opening 16F and along the side sill portions 21 and 31, roof rail portions 22 and 32, center pillar portions 24 and 34, and the lower halves of rear pillar portions 25 and 35 of the rear door opening 16R, for example. Likewise, the laser welds L at the outer flanges 20o and 30o are provided along the outer edges of the roof rail portions 22 and 32, for example. Details of the laser welding between the inner panel 20 and stiffener 30 are described below.

As shown in FIG. 3, the inner panel 20, stiffener 30, and outer panel 40 have their inner flanges 20i, 30i, and 40i, as well as outer flanges 20o, 30o, and 40o, joined together by spot welding at spots between the adjacent laser welds L. Note that a reference sign S in FIG. 3 denotes a spot weld S formed in a nugget shape by spot welding. The spot welds S of the embodiment at the inner flanges 20i, 30i, and 40i are made along the entire periphery of the front door opening 16F and along the side sill portions 21, 31, and 41, roof rail portions 22, 32, and 42, center pillar portions 24, 34, and 44, and the lower halves of rear pillar portions 25, 35, and 45 of the rear door opening 16R, for example. Likewise, the spot welds S at the outer flanges 20o, 30o, and 40o are provided along the outer edges of the roof rail portions 22, 32, and 42, for example. Here, the outer panel 40 is joined to the inner panel 20 and stiffener 30 only by the spot welds S and free from the laser welds L, as shown in FIG. 3. Details of the spot welding between the inner panel 20, stiffener 30, and outer panel are described below.

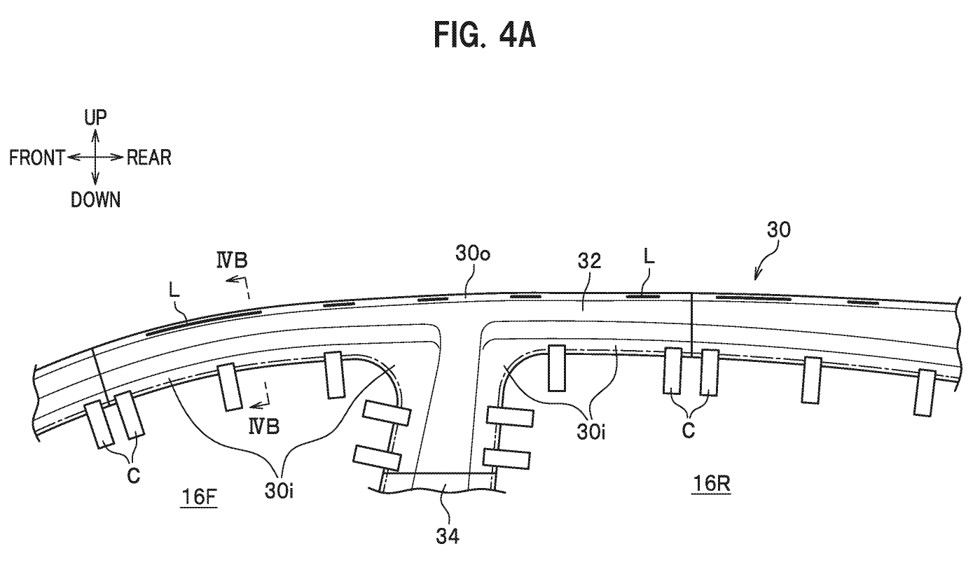

Next, a method of manufacturing the vehicle body frame structure 10 according to the embodiment is described with reference to FIGS. 4 to 11. Note that a description is given hereinbelow of the manufacturing method and FIGS. 4 to 11, taking upper ends and their vicinities of the roof rail portions 22, 32, and 42 as well as center pillar portions 24, 34, and 44, which are parts of the vehicle body frame structure 10, for example for the purpose of illustration, yet other parts are also manufactured using the same method. The method of manufacturing the vehicle body frame structure 10 according to the embodiment includes: a clamping step; a laser welding step; a clamping release step; and a spot welding step.

### Clamping Step

The clamping step involves superposing the inner panel 20 and stiffener 30 and clamping the inner flanges 20i and 30i using clamp members C, as shown in FIGS. 4A and 4B. The clamp member C is not limited to a specific type as long as it can fix the superposed sheet materials, and a hand vise, which is a kind of toggle clamp, may be used for example. The clamp members C are provided at spots where spot welding is executed in the subsequent spot welding step to be described below. The clamp members C are spaced apart in the longitudinal direction. Clamping the inner flanges 20i and 30i with the clamp members C limits a gap between the inner flanges 20i and 30i to be equal to or less than a predetermined value. Note that dashed lines drawn between the adjacent clamp members C indicate sections where laser welding is to be executed. The outer flanges 20o and 30o in FIGS. 4A and 4B indicate that they are already joined by the laser welds L.

### Laser Welding Step

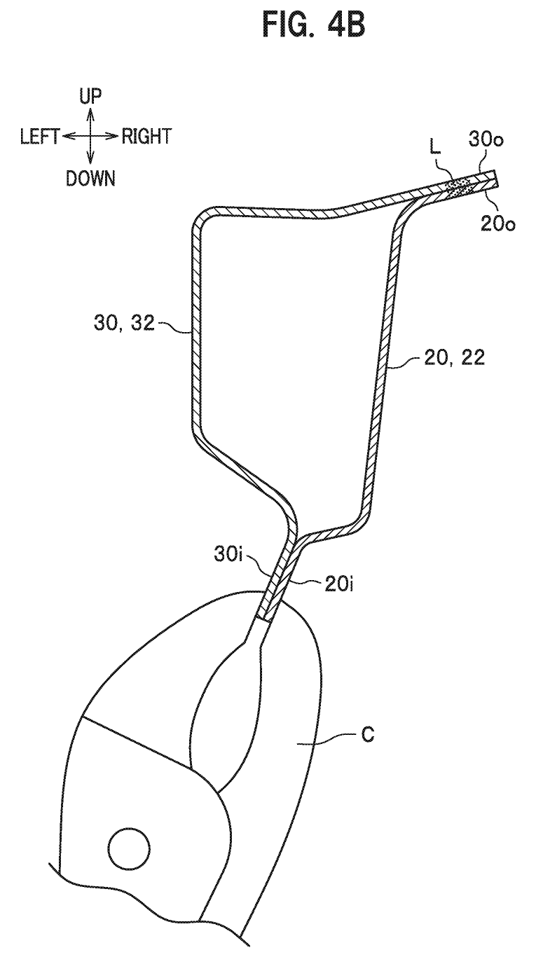

After the clamping step, the laser welding step is executed. In the laser welding step, continuous laser welding is executed between the adjacent clamp members C, as shown in FIG. 5. This forms a number of the laser welds L of predetermined length along the periphery of the door opening 16, to join the inner flanges 20i and 30i of the inner panel 20 and stiffener 30.

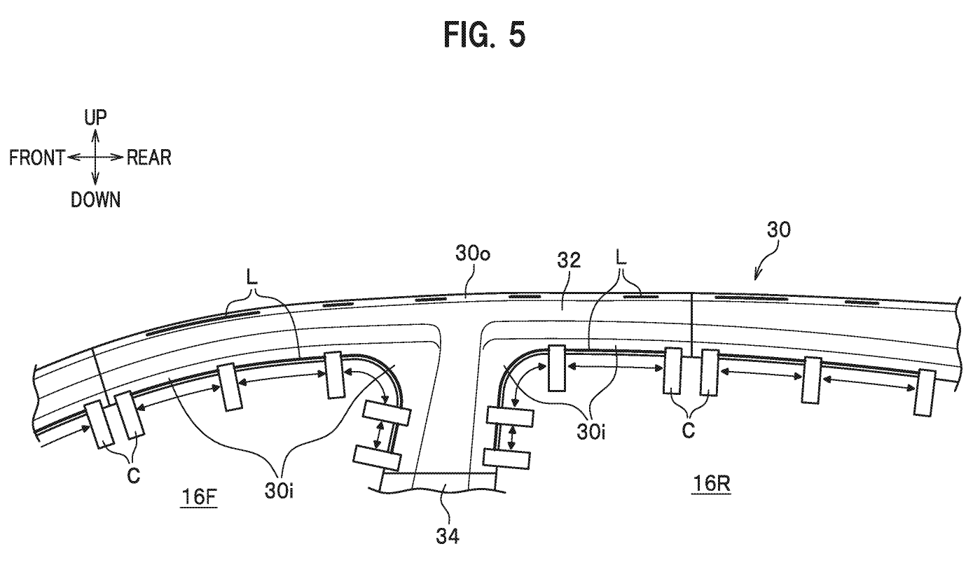

Here, the laser welding of the embodiment uses a so-called wobble welding technique. As shown in FIG. 6A, wobble welding involves controlling an optical system radiating a laser so as to draw a wobble pattern Lw, to increase a melted amount in a width direction of a weld. Wobble welding allows the weld bead to form wider, as compared with a case of linearly controlling the optical system. In addition, wobble welding stirs and flows weld bead (molten pool) by a laser, as shown in FIG. 6B. This prevents blowholes from being generated. Further, when the surfaces of the high-tensile steel sheets of the inner panel 20 and outer panel 40 are coated with aluminum plating 20a and 30a, for example, the molten aluminum plating 20a and 30a inside the molten pool flows out and disperses, to inhibit the aluminum plating 20a and 30a from being locally concentrated to degrade strength.

### Clamping Release Step

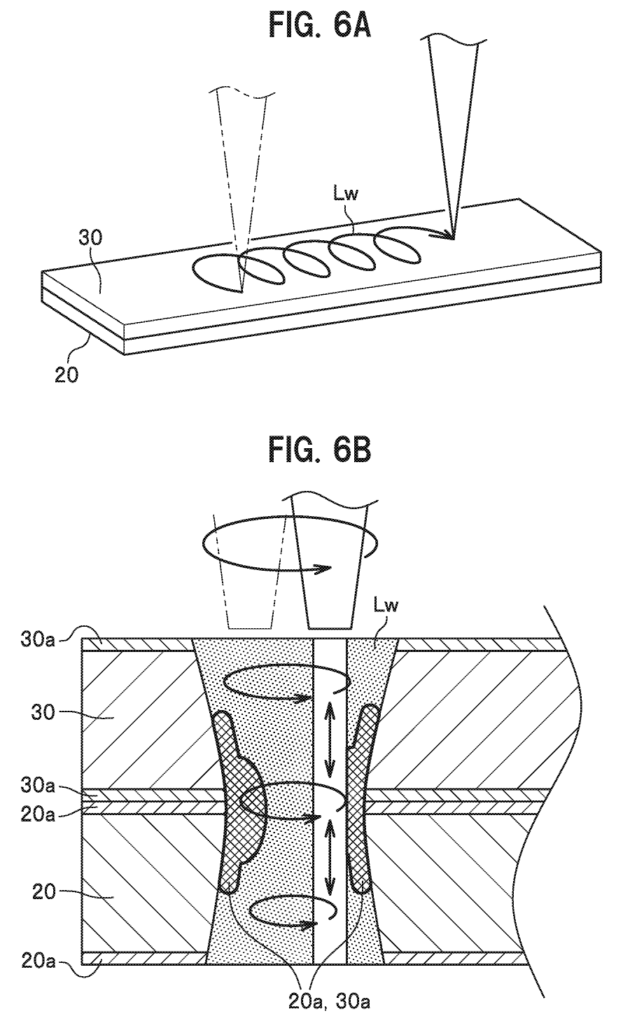

After the laser welding step is completed, the clamping release step is executed. In the clamping release step, the clamp members C used to clamp the inner panel 20 and the stiffener 30 are disengaged to release the clamping, as shown in FIG. 7. In FIG. 7, the clamp members C are illustrated with virtual lines (dashed lines) at the spots where they were used. The spots where the clamp members C were used are free from the laser welds L.

### Spot Welding Step

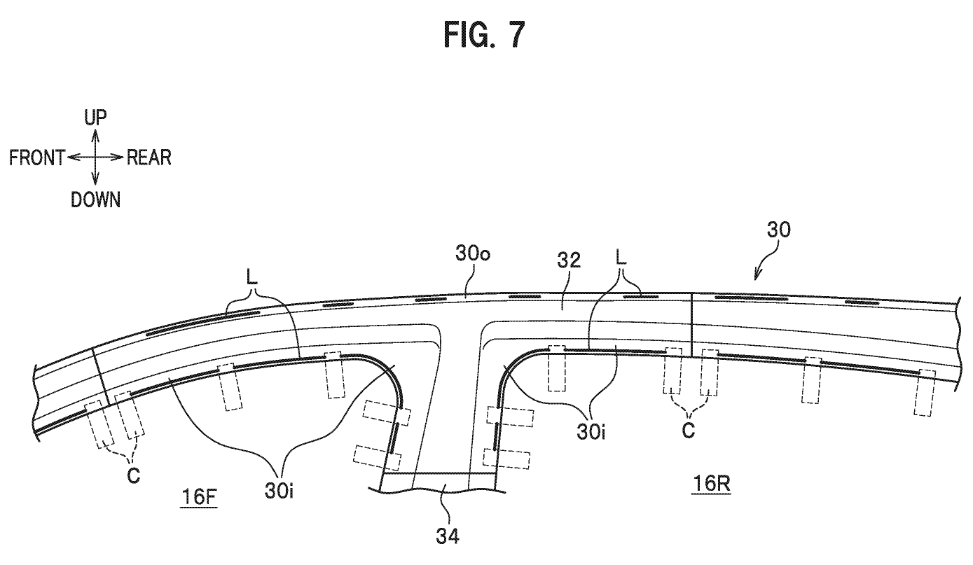

After the clamping release step, the spot welding step is executed. First, the outer panel 40 is superposed on the exterior side of the inner panel 20 and stiffener 30, which have already been joined by laser welding, as shown in FIGS. 8 and 10. At this time, the inner panel 20, stiffener 30, and outer panel 40 are fixed together using suitable means.

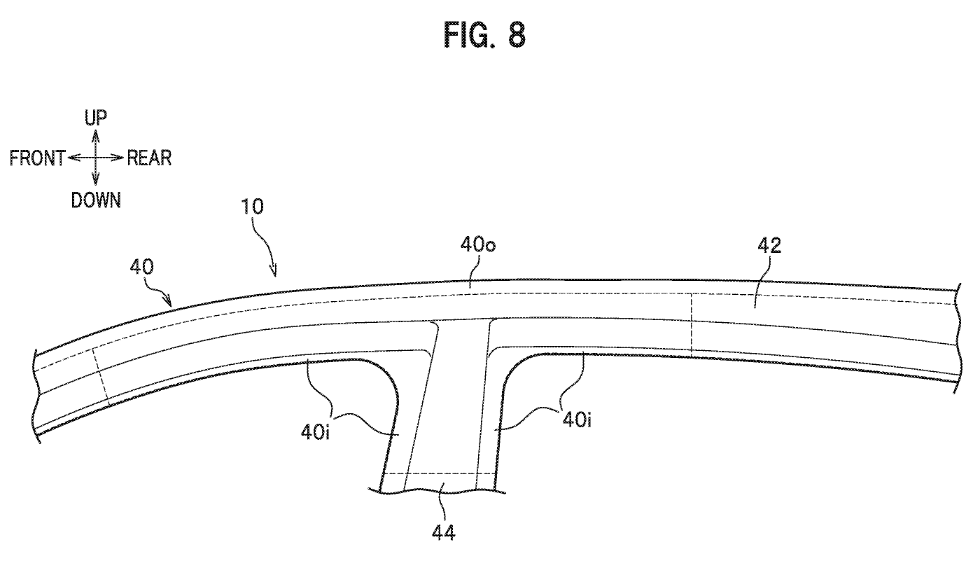

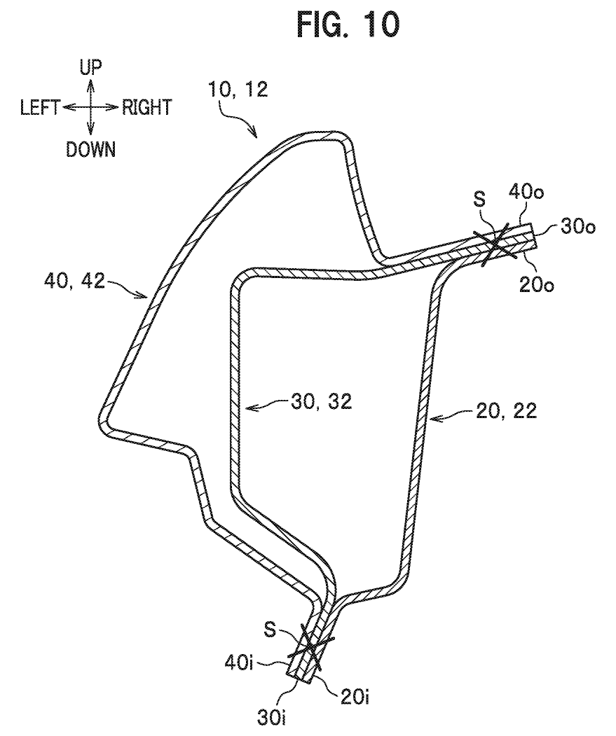

Next, the inner flanges 20i, 30i, and 40i, as well as outer flanges 20o, 30o, and 40o, of the inner panel 20, stiffener 30, and outer panel 40 are spot welded at spots between the adjacent laser welds L, as shown in FIGS. 9, 10, and 11. This forms a number of the spot welds S on the inner flanges 20i, 30i, and 40i, as well as outer flanges 20o, 30o, and 40o. The spot weld S has a nugget N spanning the inner flanges 20i, 30i, and 40i (or the outer flanges 20o, 30o, 40o) of the inner panel 20, stiffener 30, and outer panel 40, as shown in FIG. 11. The nugget N is spaced apart from the adjacent laser welds L on both sides thereof. Note that a reference sign E in FIG. 11 denotes an electrode of a spot welding device. The vehicle body frame structure 10 according to the embodiment is finished through these steps.

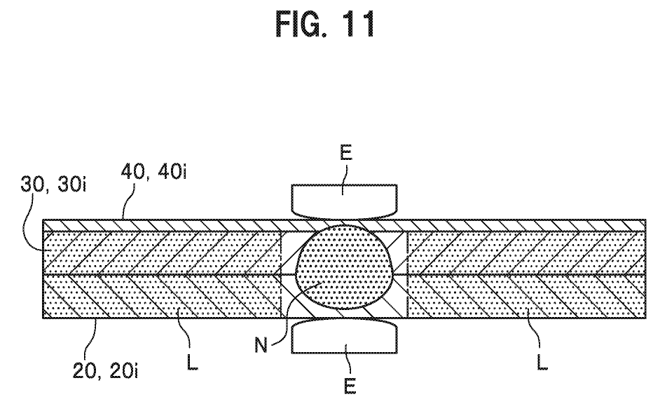

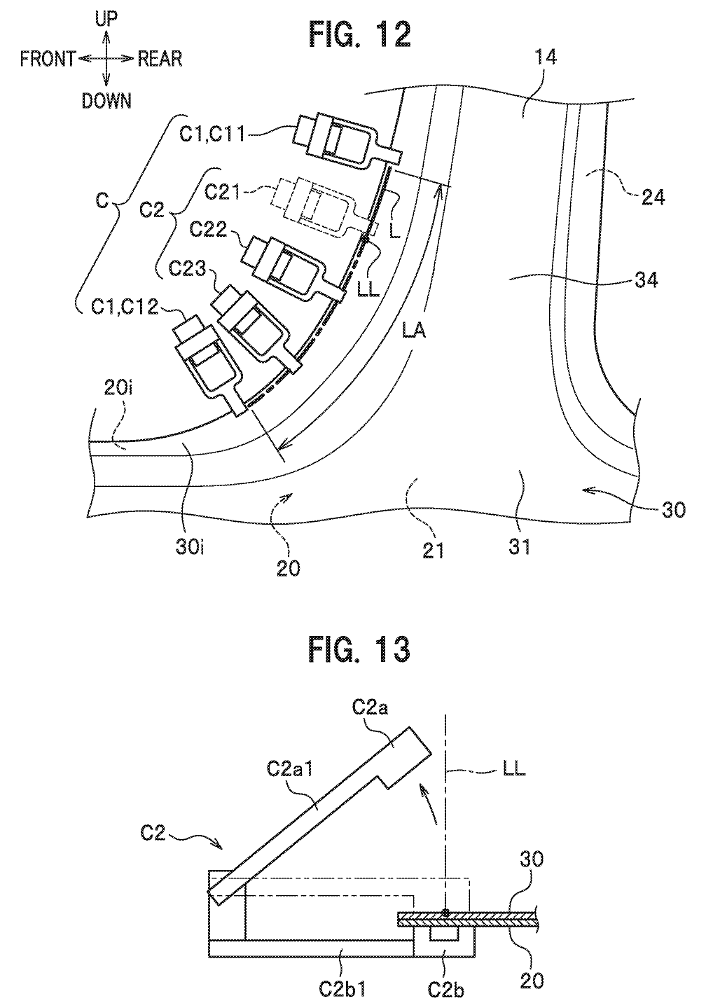

Next, details of the laser welding step are described with reference to FIGS. 12 and 13. FIG. 12 is a partially enlarged view of the lower end and its vicinity of the center pillar during the laser welding step. For example, the laser weld L is desirably formed as long as possible at the lower end and its vicinity of the center pillar 14 so as to enhance crashworthiness, but increasing the interval between the clamp members C may result in a larger gap between the inner panel 20 and stiffener 30, to inhibit gaining the required weld strength.

Accordingly, the embodiment has the three clamp members C (hereinbelow referred to as "movable clamps C2"), which are released at the time of laser welding, placed between the two clamp members C (hereinbelow referred to as "fixed clamps C1") which are placed apart, as shown in FIG. 12. These clamp members C clamp the inner flange 20i of the inner panel 20 and the inner flange 30i of the stiffener 30.

The two fixed clamps C1 keep clamping during the laser welding step and are made to release the clamping in the subsequent spot welding step. The laser weld L is formed in an area LA between the two fixed clamps C1. In contrast, the three movable clamps C2 are sequentially made to release the clamping in the laser welding step. For example, a laser beam LL scans from an upper fixed clamp C11 toward a lower fixed clamp C12, to start forming the laser weld L from the upper fixed clamp C11. As the laser beam LL approaches a movable clamp C21 closest to the upper fixed clamp C11, the clamping by the movable clamp C21 is released.

After the movable clamp C21 has been made to release the clamping, the laser beam LL passes through the spot previously clamped by the movable clamp C21, to form the laser weld L continuously, as shown in FIG. 12. When the laser beam LL advances further to approach a movable clamp C22, the clamping by the movable clamp C22 is released, and the laser weld L is formed continuously at the spot previously clamped by the movable clamp C22. When the laser beam LL advances further to approach a movable clamp C23, the clamping by the movable clamp C23 is released, and the laser weld L is formed continuously at the spot previously clamped by the movable clamp C23. This allows for forming the laser welding L continuously without degradation in strength due to the gap, even when the area LA between the two fixed clamps C1 is wide.

FIG. 13 is a schematic side view of the movable clamp. As shown in FIG. 13, the movable clamp C2 includes a main body C2b placed under the inner panel 20 and an action C2a positioned above the stiffener 30. The action C2a has an arm portion C2a1 extending toward the center of the door opening 16. The main body C2b includes a bracket portion C2b1 supporting a base end of the arm portion C2a1 pivotally about a horizontal axis. When the action C2a is pivoted upward, the clamping by the movable clamp C2 is released. At this time, a front end of the action C2a is moved to a position where the action C2a is not irradiated with the laser beam LL. Note that the action C2a before being pivoted is illustrated with a virtual line (two-dot chain line) in FIG. 13. The action C2a may be pivoted by an actuator of a robot arm (not shown), for example. The timing of releasing the clamping by the movable clamp C2 is determined based on the scanning speed of the laser beam LL and a distance between the laser beam LL and the movable clamp C2. For example, the robot arm may be controlled to release the clamping by the movable clamp C2 when the laser beam LL approaches within 1 to 1.5 cm to the movable clamp C2.

Next, a description is given of advantageous effects of the method of manufacturing the vehicle body frame structure according to the embodiment.

The method of manufacturing the vehicle body frame structure 10 according to the embodiment is used to manufacture the vehicle body frame structure 10 with the inner panel 20, stiffener 30, and outer panel 40 made of galvanized steel sheet superposed in this order from the interior side of the vehicle and the inner flanges 20i, 30i, and 40i, as well as outer flanges 20o, 30o, and 40o, respectively provided on the inner panel 20, stiffener 30, and outer panel 40, joined together, the method including: the clamping step of superposing and clamping the inner flanges 20i and 30i, as well as outer flanges 20o and 30o, of the inner panel 20 and stiffener 30 using a number of the clamp members C placed at intervals; the laser welding step of executing continuous laser welding between the adjacent clamp members C to form a number of the laser welds L of predetermined length to join the inner flanges 20i and 30i, as well as outer flanges 20o and 30o, of the inner panel 20 and stiffener 30; the clamping release step of disengaging the clamp members C; and the spot welding step of superposing the outer panel 40 on the exterior side of the laser-welded inner panel 20 and stiffener 30, and spot welding the inner flanges 20i, 30i and 40i, as well as outer flanges 20o, 30o and 40o, of the inner panel 20, stiffener 30, and outer panel 40, at spots between the adjacent laser welds L, to form a number of the spot welds S. According to such a configuration, the inner panel 20 and stiffener 30 are continuously welded by laser welding, to allow for forming a highly rigid vehicle body frame. Any gap between the inner panel 20 and stiffener 30 can cause defects in laser welding, so that clamping them to eliminate any gap and then laser welding sections between the clamps ensures high-quality in laser welding. Moreover, only the two panels contributing to rigidity – the inner panel 20 and stiffener 30 – are laser welded, so that manufacturing energy is reduced, as compared with laser welding the three panels inclusive of the outer panel 40. In addition, the outer panel 40 to form the exterior surface is made of galvanized material for corrosion resistance. Laser welding galvanized material can cause a rearward of the laser irradiated area to expand and explode with gas due to evaporation of zinc plating and then solidify in that state to generate blowholes, to have difficulty in ensuring weld quality. Then, joining the inner panel 20 and stiffener 30 by laser welding to ensure rigidity as a vehicle body frame, followed by superposing the outer panel 40 and spot welding the panels, to enhance both rigidity and a welding property. Additionally, the three panels are spot welded at the spots where the inner panel 20 and stiffener 30 have been clamped, to have the inner panel 20 and stiffener 30 joined more solidly to enhance rigidity.

Further, the method of manufacturing the vehicle body frame structure 10 may also be configured such that a number of the clamp members C includes the movable clamps C2 which are released in the laser welding step, and the fixed clamps C1 which keep clamping in the laser welding step, wherein the movable clamps C2 are placed at spots between the two fixed clamps C1, and the laser welding step includes a step of releasing the movable clamps C2 one by one when the laser beam LL scanning between the two fixed clamps C1 approaches one of the movable clamps C2, and continuously laser welding the spots clamped by the movable clamps C2. According to such a configuration, the movable clamps C2 are placed between the two spaced fixed clamps C1 to keep a gap between the inner panel 20 and stiffener 30 small, and clamping by the movable clamps C2 is released when the scanning laser beam LL approaches, to allow for seamlessly laser welding between the two fixed clamps C1, while maintaining welding quality.

Still further, the inner panel 20 and stiffener 30 are each made of high-tensile material, and the laser welding step may involve scanning the laser beam LL along the weld line, while wobbling. Such a procedure joins high-tensile materials with high strength continuously by laser welding, to allow for forming a highly rigid vehicle body frame. Additionally, wobble welding the panels while forcibly stirring the molten pool allows for preventing blowholes from being generated, to ensure welding quality. Moreover, when a hot press material is used as a kind of high-tensile material, aluminum components may separate and solidify when the hot press material is laser welded, to have defect areas with aluminum highly concentrated. To address this problem, wobble welding can be used, when a hot press material is laser welded, to forcibly stir the molten pool and disperse aluminum plating components within the molten pool, to inhibit having defect areas.

Still further, the vehicle body frame structure 10 according to the embodiment is manufactured with the inner panel 20, stiffener 30, and outer panel 40 superposed in this order from the interior side of the vehicle and the inner flanges 20i, 30i, and 40i, as well as outer flanges 20o, 30o, and 40o, respectively provided on the inner panel 20, stiffener 30, and outer panel 40, joined together. The inner flanges 20i and 30i, as well as outer flanges 20o and 30o, of the inner panel 20 and stiffener 30 are joined together at a number of the laser welds L formed to a predetermined length by continuous laser welding. Additionally, the inner flanges 20i, 30i, and 40i, as well as outer flanges 20o, 30o, and 40o, of the inner panel 20, stiffener 30, and outer panel 40 are joined together between the adjacent laser welds L at spot welds S formed by spot welding. Such a procedure continuously welds the inner panel 20 (first metal sheet) and stiffener 30 (second metal sheet) at the laser welds L, to form a vehicle body frame with highly rigidity. Moreover, laser welding only two panels – the inner panel 20 and stiffener 30 – allows for reducing manufacturing energy, as compared with laser welding three panels inclusive of the outer panel 40. Then, the outer panel 40 is spot welded between the laser welds L to the laser-welded inner panel 20 and stiffener 30, to further strengthen joining between the inner panel 20 and stiffener 30 to further enhance rigidity.

Still further, the outer panel 40 is free from the laser welds L. In other words, the outer panel 40 is joined to the inner panel 20 and stiffener 30 only at spot welds S. Such a configuration allows the outer panel 40 to be free from the laser welds L, even when the outer panel 40 is made of galvanized steel sheet, with no fear of blowholes being generated. Thus, the inner panel 20 and stiffener 30 are joined by laser welding to secure rigidity for a vehicle frame, and then the outer panel 40 made of galvanized steel sheet is superposed and spot welded, to gain both rigidity and a welding property

Still further, the spot weld S has the nugget N spanning the inner flanges 20i, 30i, and 40i, or the outer flanges 20o, 30o, and 40o, of the inner panel 20, stiffener 30, and outer panel 40. Such a configuration with the nugget spanning the inner panel 20, stiffener 30, and outer panel 40 ensures reliable joining of the outer panel 40 to the inner panel 20 and stiffener 30. Moreover, the inner panel 20 and stiffener 30 are joined not only at the laser welds L but also at the spot welds S, to make the joining even stronger to enhance rigidity.

Still further, the inner flanges 20i, 30i, and 40i are formed along the peripheries of the front door opening 16F and rear door opening 16R. Such a configuration has the vehicle body frame structure 10 of the embodiment applied to the door opening 16, which significantly contributes to rigidity, to effectively enhance rigidity and thus lead to weight reduction.

Hereinabove, the embodiment of the present invention has been described, but the present invention is not limited to the embodiment and can be modified as appropriate without departing from the scope of the present invention. For example, the three movable clamps C2 are placed between the two fixed clamps C1 in the embodiment, but the invention is not limited to this in number. The one, or four or more movable clamps C2 may be placed between the two fixed clamps C1.

In addition, the outer panel 40 is integrally formed of a single galvanized steel sheet in the embodiment, but the present invention is not limited to this. For example, the outer panel 40 may be divided into, and formed of, multiple galvanized steel sheets.

Further, the laser welds L around the rear door opening 16R at the inner flanges 20i and 30i are provided in the embodiment along the side sill portions 21 and 31, roof rail portions 22 and 32, center pillar portions 24 and 34, and the lower halves of rear pillar portions 25 and 35 (the upper halves of the rear pillar portions 25 and 35 are free from the laser welds L; see FIG. 2), but a number of the laser welds L may be made around the entire periphery of the rear door opening 16R.

Furthermore, the present invention is applied in the embodiment to the frame structure around the door on a side of the vehicle body, but it may also be applied to other portions of the vehicle body frame structure.

### LIST OF REFERENCE SIGNS

10: vehicle body frame structure, 16: door opening, 16F: front door opening, 16R: rear door opening, 20: inner panel, 30: stiffener, 40: outer panel, 21; 31; 41: side sill portion, 22; 32; 42: roof rail portion, 23; 33; 43: center pillar portion, 25; 35; 45: rear pillar portion, 20i; 30i; 40i: inner flange, 20o; 30o; 40o: outer flange, L: laser weld, Lw: wobble weld mark, S: spot weld, C: clamp member, C1: fixed clamp, and C2: movable clamp.

What is claimed is:

1. A method of manufacturing a vehicle body frame structure with an inner panel, a stiffener, and an outer panel made of galvanized steel sheet superposed in this order from an interior side of a vehicle and flanges, respectively provided on the inner panel, stiffener, and outer panel, joined together, the method comprising:
a clamping step of superposing and clamping the flanges of the inner panel and stiffener to each other using a number of clamp members placed at intervals;
a laser welding step of executing continuous laser welding between the adjacent clamp members to form a number of laser welds of predetermined length to join the flanges of the inner panel and stiffener;
a clamping release step of disengaging the clamp members; and
a spot welding step of superposing the outer panel on an exterior side of the laser-welded inner panel and stiffener, and spot welding the flanges of the inner panel, stiffener, and outer panel, at spots between the adjacent laser welds, to form a number of spot welds.

2. The method of manufacturing the vehicle body frame structure according to claim 1, wherein
a number of the clamp members includes at least one movable clamp which is released in the laser welding step, and at least one fixed clamp which keeps clamping in the laser welding step,
wherein the at least one movable clamp is placed between the two fixed clamps, and
the laser welding step includes a step of releasing the at least one movable clamp one by one when a laser beam scanning between the two fixed clamps approaches one of the at least one movable clamp, and continuously laser welding a spot or spots clamped by the at least one movable clamp.

3. The method of manufacturing the vehicle body frame structure according to claim 1, wherein
at least one of the inner panel and stiffener is made of high-tensile material, and
the laser welding step involves scanning a laser beam along a weld line, while wobbling.
